(19) United States
(12) Patent Application Publication
(10) Pub. No.: US 2018/0357672 A1
(43) Pub. Date: Dec. 13, 2018

(54) METHOD FOR ADVERTISING BASED ON POSITION AND SYSTEM THEREOF

(71) Applicant: Woowa Brothers Co., Ltd, Seoul (KR)

(72) Inventors: Bong Jin KIM, Seoul (KR); Soo Kwon KIM, Seongnam-si (KR); Jeong Bin PARK, Namyangju-si (KR)

(21) Appl. No.: 15/779,847

(22) PCT Filed: Nov. 10, 2016
(86) PCT No.: PCT/KR2016/012898

§ 371 Date: May 30, 2018

(30) Foreign Application Priority Data
Nov. 30, 2015 (KR) 10-2015-0169138

(51) Int. Cl. G06Q 30/02

(52) U.S. Cl. CPC G06Q 30/0261; G06Q 30/0277; G06Q 30/0275

(57) ABSTRACT

A location-based advertising method and a system therefor, including the operations of: identifying a location of a client terminal; determining at least one first advertisement information and at least one second advertisement information, based on the location of the client terminal, to be exposed in a first advertisement area and a second advertisement area, respectively, displayed on the client terminal; and causing the at least one first advertisement information and the at least one second advertisement information to be exposed in the first advertisement area and the second advertisement area, respectively. The at least one first advertisement information is determined based on a result of a bidding performed for regional units and the location of the client terminal. The at least one second advertisement information is determined based on the location of the client terminal and an advertiser correspondence location corresponding to each advertisement information.

### CROSS-REFERENCE TO RELATED APPLICATIONS

This application is a National Stage Entry of International Application No. PCT/KR2016/012898, filed on Nov. 10, 2016, and claims priority from and the benefit of Korean Patent Application No. 10-2015-0169138, filed on Nov. 30, 2015, which are hereby incorporated by reference for all purposes as if fully set forth herein.

### BACKGROUND

### Field

Exemplary embodiments of the invention relate generally to a method and system for providing advertisement information differentiated according to a location of a user. More particularly, the present disclosure relates to a method and system for allowing an advertiser to bid on a regional basis and facilitating an efficient and fair advertisement by taking a bidding is result into account together with another various factors.

### Discussion of the Background

Since users tend to refer to information acquired online on their consumption, it is considered as a very important factor in business how to expose advertisement information for promoting a specific business entity to the users in an online environment.

The significance of such an exposure scheme has been issued, in an environment where most information is distributed through portal sites, as a matter of determining which advertisement information is to be exposed or in which position the exposed advertisement information is to be disposed on a web page when a user performs a keyword search.

Providing the advertisement information effectively and fairly to users is a very important factor not only in the portal site oriented environment but also in a mobile environment which is popularized nowadays.

In particular, as the mobile environment is expanding, channels (e.g., mobile applications) used for providing information or services are being diversified, and thus there is a need for an advertising method that may be specialized according to a type of a service in addition to uniform advertising methods provided conventionally by the portal sites.

Further, since a location of the user or a client terminal can be identified easily in the mobile environment, a method of exposing the advertisement information to a user effectively and fairly according to the location of the user and properties of the service is required.

(Patent Literature 1) Korean patent publication No. 10-1324106 entitled ADVERTISE EXPOSURE RANKING MANAGEMENT APPARATUS AND METHOD USING CLIENT POSITION

The above information disclosed in this Background section is only for understanding of the background of the inventive concepts, and, therefore, it may contain information that does not constitute prior art.

### SUMMARY

Exemplary embodiments of the inventive concepts provide methods and systems for providing fairly chances of effectively exposing advertisements of the advertisers who provide their services based on predetermined locations such as facilities of respective advertisers.

Exemplary embodiments of the inventive concepts provide methods and systems for selecting an advertiser through a bidding for each position where advertisement is exposed on the client terminal, and calculating the advertising impact reasonably for a predetermined past time period for each advertisement position to provide to the advertisers, so that the advertisers may avoid or reduce economic burdens arising from excessive advertising costs in consideration of advertising impact effect.

Exemplary embodiments of the inventive concepts provide methods and systems for providing another advertisement position that is irrelevant to the bidding result along with the advertisement position determined based on the bidding result, so as to prevent advertisements from being monopolized by affluent advertisers and allow the advertisers to perform their advertisements with little cost constraints.

Exemplary embodiments of the inventive concepts provide methods and systems for setting and using an advertiser correspondence region based on an advertiser correspondence location when the advertisement to be exposed is determined, so as to provide the advertisements is to client terminals reflecting an actual commercial (when each advertiser has some coverage area for service providing).

According to an aspect of an exemplary embodiment, a location-based advertising method includes: identifying a location of a client terminal by a location-based advertising system; determining at least one first advertisement information and at least one second advertisement information, based on the location of the client terminal, to be exposed in a first advertisement area and a second advertisement area, respectively, displayed on the client terminal; and causing the at least one first advertisement information and the at least one second advertisement information to be exposed in the first advertisement area and the second advertisement area, respectively. The at least one first advertisement information is determined based on a result of a bidding performed for regional units and the location of the client terminal. The at least one second advertisement information is determined based on the location of the client terminal and an advertiser correspondence location corresponding to each advertisement information.

The location-based advertising method may further include an operation of: performing a bidding process for each of product classifications by the location-based advertising system. In the operation of determining the at least one first advertisement information and the at least one second advertisement information, after a particular product classification is selected by the client terminal, advertisement information of a bid-winning advertiser having acquired a regional unit corresponding to the location of the client terminal for the particular product classification may be determined as the first advertisement information.

The operation of determining the at least one first advertisement information and the at least one second advertisement information may include operations of: determining whether the location of the client terminal satisfies a correspondence region condition that the location of the client terminal belongs to an advertiser correspondence region of the bid-winning advertiser that is predetermined based on an advertiser correspondence location of the bid-winning advertiser; and determining the advertisement information of the bid-winning advertiser as the first advertisement information only when the location of the client terminal satisfies the correspondence region condition.

The operation of determining the at least one first advertisement information and the at least one second advertisement information may further include an operation of: when the location of the client terminal does not satisfy the correspondence region condition, determining the advertisement information of the bid-winning advertiser as neither the first advertisement information nor the second advertisement information.

The advertiser correspondence region may be a region that falls within a predetermined radius from the advertiser correspondence location. The radius may be set differently for each of the product classifications.

When a portion of the regional unit acquired by the bid-winning advertiser is not included in a reference area that falls within a predetermined radius from the advertiser correspondence location, the advertiser correspondence region may be set to include the portion of the regional unit acquired by the bid-winning advertiser or to include a drawing region designated on a map in a predetermined terminal.

The first advertisement area may include a plurality of predetermined advertisement positions, and a bid-winning advertiser may be determined for each of the plurality of predetermined advertisement positions based on the result of the bidding.

The operation of causing the at least one first advertisement information and the at least one second advertisement information to be exposed may include an operation of: when it is determined that a first bid-winning advertiser having acquired a first advertisement position does not satisfy the correspondence region condition for a first advertisement position and a second bid-winning advertiser having acquired a second advertisement position which has a lower priority than the first advertisement position satisfies the correspondence region condition for the first advertisement position, causing advertisement information of the second bid-winning advertiser to be exposed in the first advertisement position having a higher priority than the second advertisement position.

The location-based advertising method may further include an operation of: performing a bidding process for each of at least one advertisement position in the first advertisement area including the at least one advertisement position. The operation of performing the bidding process may include operations of: calculating a reference bidding price for each of the at least one advertisement position based on an economic value of orders generated in a predetermined past period of time through the each of at least one advertisement position; and performing the bidding process based on the reference bidding price calculated for each of the at least one advertisement position.

The orders generated through the each of at least one advertisement position may include orders placed through advertisement information of advertisers other than the bid-winning advertiser in addition to the bid-winning advertiser.

The advertiser correspondence region may include a location of a facility of an advertiser, and optionally a position chosen by the advertiser.

In the operation of determining the at least one first advertisement information and the at least one second advertisement information, after a particular product classification is is selected by the client terminal, advertisement information of a second advertiser who is not the bid-winning advertiser among advertisers corresponding to the particular product classification and whose advertiser correspondence region covers the location of the client terminal may be determined as the second advertisement information.

The operation of causing the at least one first advertisement information and the at least one second advertisement information to be exposed may include an operation of: exposing the advertisement information of the at least one second advertiser in an advertisement position having a high priority in an order of the closest distance between the advertiser correspondence location of each of the at least one second advertisers and the location of the client terminal.

According to another aspect of an exemplary embodiment, a location-based advertising method includes: identifying a location of a client terminal by a location-based advertising system; determining at least one advertisement information to be exposed in a predetermined advertisement area displayed on the client terminal; and causing the at least one advertisement information to be exposed in the predetermined advertisement area. The at least one advertisement information may include advertisement information of a bid-winning advertiser having acquired a regional unit corresponding to the location of the client terminal for the particular product classification selected by the client terminal.

The operation of determining the at least one advertisement information to be exposed in the predetermined advertisement area may include operations of: determining whether the location of the client terminal satisfies a correspondence region condition that the location of the client terminal belongs to an advertiser correspondence region of the bid-winning advertiser that is predetermined based on an advertiser correspondence location of the bid-winning advertiser; and determining the advertisement information of the bid-winning advertiser as the advertisement information only when the location of the client terminal satisfies the correspondence region condition.

According to yet another aspect of an exemplary embodiment, a location-based advertising method includes: performing a bidding process for each of at least one advertisement position to determine at least one advertisement information to be exposed in an advertisement area, including the at least one advertisement position, that is to be displayed on a client terminal; and determining the at least one advertisement information to be exposed in the advertisement area based on a location of the client terminal and a result of the bidding process. The operation of performing the bidding process for each of at least one advertisement position may include operations of: calculating a reference bidding price for each of the at least one advertisement position based on an economic value of orders generated in a predetermined past period of time through the each of at least one advertisement position; and performing the bidding process based on the reference bidding price calculated for each of the at least one advertisement position.

According to still yet another aspect of an exemplary embodiment, a location-based advertising method includes: selecting a bid-winning advertiser by performing a bidding process for each of plural advertisement positions to expose advertisement information in an advertisement area including the plural advertisement positions; identifying a location of a client terminal; and determining at least one advertisement information to be exposed in the advertisement area, which includes the plural advertisement positions and is to be displayed on the client terminal, based on the location of the client terminal. The operation of determining at least one advertisement information includes: when it is determined that a first bid-winning advertiser having acquired a first advertisement position does not satisfy a correspondence region condition for a first advertisement position and a second bid-winning advertiser having acquired a second advertisement position which has a lower priority than the first advertisement position satisfies the correspondence region condition for the first advertisement position, causing advertisement information of the second bid-winning advertiser to be exposed in the first advertisement position having a higher priority than the second advertisement position. The correspondence region condition is determined to be satisfied when an advertiser correspondence region of an advertiser that is predetermined based on an advertiser correspondence location of the advertiser covers the location of the client terminal.

According to an aspect of another exemplary embodiment, provided is a computer program stored in a computer-readable storage medium to be installed in a data processing apparatus and for executing the location-based advertising methods described above.

According to an aspect of yet another exemplary embodiment, a location-based advertising system includes: a client module configured to identify a location of a client terminal; an advertisement determination module configured to determine at least one first advertisement information and at least one second advertisement information, based on the location of the client terminal, to be exposed in a first advertisement area and a second advertisement area, respectively, displayed on the client terminal; and a control module configured to cause the at least one first advertisement information and the at least one second advertisement information to be exposed in the first advertisement area and the second advertisement area, respectively. The advertisement determination module determines the at least one first advertisement information based on a result of a bidding performed for regional units and the location of the client terminal, and determines the at least one second advertisement information based on the location of the client terminal and an advertiser correspondence location of a corresponding advertiser.

The location-based advertising system may further include a bidding module configured to perform a bidding process for each of product classifications. After a particular product classification is selected by the client terminal, the advertisement determination module may determine advertisement information of a bid-winning advertiser having acquired a regional unit including the location of the client terminal for the particular product classification as the first advertisement information.

The advertisement determination module may determine whether the location of the client terminal satisfies a correspondence region condition that the location of the client terminal belongs to an advertiser correspondence region of the bid-winning advertiser that is predetermined based on an advertiser correspondence location of the bid-winning advertiser; and determine the advertisement information of the bid-winning advertiser as the first advertisement information only when the location of the client terminal satisfies the correspondence region condition.

The first advertisement area may include a plurality of predetermined advertisement positions, and the bid-winning advertiser may be determined for each of the plurality of predetermined advertisement positions based on the result of the bidding.

When it is determined that a first bid-winning advertiser having acquired a first advertisement position does not satisfy the correspondence region condition for a first advertisement position and a second bid-winning advertiser having acquired a second advertisement position which has a lower priority than the first advertisement position satisfies the correspondence region condition for the first advertisement position, the control module may cause advertisement information of the second bid-winning advertiser to be exposed in the first advertisement position having a higher priority than the second advertisement position.

The location-based advertising system may further include a bidding module configured to perform a bidding process for each of at least one advertisement position in the first advertisement area including the at least one advertisement position. Acquired bidding module may calculate a reference bidding price for each of the at least one advertisement position based on an economic value of orders generated in a predetermined past period of time through the each of at least one advertisement position, and perform the bidding process based on the reference bidding price calculated for each of the at least one advertisement position.

After a particular product classification is selected by the client terminal, the advertisement determination module may determine advertisement information of a second advertiser who is not the bid-winning advertiser among advertisers corresponding to the particular product classification and whose advertiser correspondence region covers the location of the client terminal as the second advertisement information.

According to another aspect of yet another exemplary embodiment, a location-based advertising system includes: a client module configured to identify a location of a client terminal; an advertisement determination module configured to determine at least one advertisement information to be exposed in a predetermined advertisement area displayed on the client terminal; and a control module configured to cause the at least one advertisement information to be exposed in the predetermined advertisement area. The at least one advertisement information includes advertisement information of a bid-winning advertiser having acquired a regional unit including the location of the client terminal for the particular product classification selected by the client terminal.

The advertisement determination module may determine whether the location of the client terminal satisfies a correspondence region condition that the location of the client terminal belongs to an advertiser correspondence region of the bid-winning advertiser, and determines the advertisement information of the bid-winning advertiser as the advertisement information only when the location of the client terminal satisfies the correspondence region condition. According to yet another aspect of yet another exemplary embodiment, a location-based advertising system includes: a bidding module configured to perform a bidding process for each of at least one advertisement position to determine at least one advertisement information to be exposed in an advertisement area, including the at least one advertisement position, that is to be displayed on a client terminal; and an advertisement determination module configured to determine the at least one advertisement information to be exposed in the advertisement area based on a location of the client terminal and a result of the bidding process. The bidding module calculates a reference bidding price for each of the at least one advertisement position based on an economic value of orders generated in a predetermined past period of time through the each of at least one advertisement position, and performs the bidding process based on the reference bidding price calculated for each of the at least one advertisement position.

According to still yet another aspect of yet another exemplary embodiment, a location-based advertising system includes: a bidding module configured to select a bid-winning advertiser by performing a bidding process for each of at least one advertisement position to expose advertisement information in an advertisement area including the at least one advertisement position; a client module configured to identify a location of a client terminal; an advertisement determination module configured to determine at least one advertisement information to be exposed in the advertisement area, which includes the at least one advertisement position and is to be displayed on the client terminal, based on the location of the client terminal; and a control module configured to, when it is determined by the advertisement determination module that a first bid-winning advertiser having acquired a first advertisement position does not satisfy a correspondence region condition for a first advertisement position and a second bid-winning advertiser having acquired a second advertisement position which has a lower priority than the first advertisement position satisfies the correspondence region condition for the first advertisement position, cause advertisement information of the second bid-winning advertiser on the first advertisement position having a higher priority than the second advertisement position. The correspondence region condition is determined to be satisfied when an advertiser correspondence region of an advertiser that is predetermined based on an advertiser correspondence location of the advertiser covers the location of the client terminal.

According to an exemplary embodiment of the invention, a regional unit (e.g., an administrative district or a region divided arbitrarily by a service platform operator) may be set for an object of bidding. Thus, the inventive concepts may fairly provide chances of effectively exposing the advertisements of the advertisers who provide their services based on predetermined locations such as facilities of respective advertisers.

Also, according to an exemplary embodiment of the invention, an advertiser is selected through a bidding for each position where advertisement is exposed on the client terminal. In order to limit economic burdens of the advertisers, the advertising impact for a predetermined past time period for each advertisement position may be calculated and provided to the advertisers. Thus, the present disclosure may allow the advertisers to avoid or reduce excessive advertising costs in consideration of the advertising impact.

Also, even through the advertisement to be exposed is determined based on the bidding result, the present disclosure may provide another advertisement position irrelevant to the bidding result along with the advertisement position determined based on the bidding result. Thus, the present disclosure may prevent excessive advertising costs, and allows the advertisers to perform their advertisements with little cost constraints.

Also, an advertiser correspondence region is set based on an advertiser correspondence location when the advertisement to be exposed is determined. Accordingly, the inventive concepts may provide the advertisements to client terminals reflecting an actual commercial and advertising circumstances and prevent advertisements from being monopolized by aggressive advertisers.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 schematically illustrates a network environment of a location-based advertising system suitable for implementing a location-based advertising method according to an exemplary embodiment of the invention.

FIG. 2 is a block diagram of the location-based advertising system according to an exemplary embodiment of the invention.

FIG. 3 illustrates advertisement areas according to the location-based advertising method according to an exemplary embodiment of the invention.

FIG. 4 is a diagram for explaining a regional unit, which is a bidding object according to the location-based advertising method according to an exemplary embodiment of the invention, and an advertiser correspondence location.

FIG. 5 is a diagram for explaining a process of determining advertisement information to be exposed according to a location of a user in accordance with the location-based advertising method according to an exemplary embodiment of the invention.

FIG. 6 is a diagram for explaining a concept of setting the advertiser correspondence region according to the location-based advertising method according to an exemplary embodiment of the invention.

FIG. 7 is a diagram for explaining a concept of setting a plurality of advertiser correspondence locations according to the location-based advertising method according to an exemplary embodiment of the invention.

### DETAILED DESCRIPTION

While the inventive concepts will be described in conjunction with exemplary embodiments thereof, it is to be understood that the present description is not intended to limit the inventive concepts to those exemplary embodiments. On the contrary, the inventive concepts are intended to cover not only the exemplary embodiments, but also various alternatives, modifications, equivalents and other embodiments that may be included within the spirit and scope of the inventive concepts as defined by the appended claims. In the following description, detailed descriptions of known functions and components incorporated herein will be omitted in the case that the gist of the present disclosure is rendered unclear.

It will be understood that, although the terms “first,” “second,” and the like may be used herein to describe various elements, these elements should not be limited by these terms. These terms are only used to distinguish one element from another element.

The terminology used herein is for the purpose of describing particular embodiments only and is not intended to be limiting. As used herein, the singular forms “a,” “an” and “the” are intended to include the plural forms as well, unless the context clearly indicates otherwise.

It will be further understood that the terms “comprise”, “include”, “have”, and the like when used in this specification, specify the presence of stated features, integers, steps, operations, elements, components, and/or combinations thereof but do not preclude the presence or addition of one or more other features, integers, steps, operations, elements, components, and/or combinations thereof.

Also, it will be understood that, when an element is referred to as “transmitting” data to another element in this specification, the element can not only directly transmit data to another element but also indirectly transmit data to another element via at least one intervening element. In contrast, when an element is referred to as “directly transmitting” data to another element, the element can transmit the data to another element without an intervening element.

Hereinbelow, exemplary embodiments of the present disclosure will be described in more detail with reference to the accompanying drawings. The same components are designated by the same reference numerals although they are illustrated in different drawings.

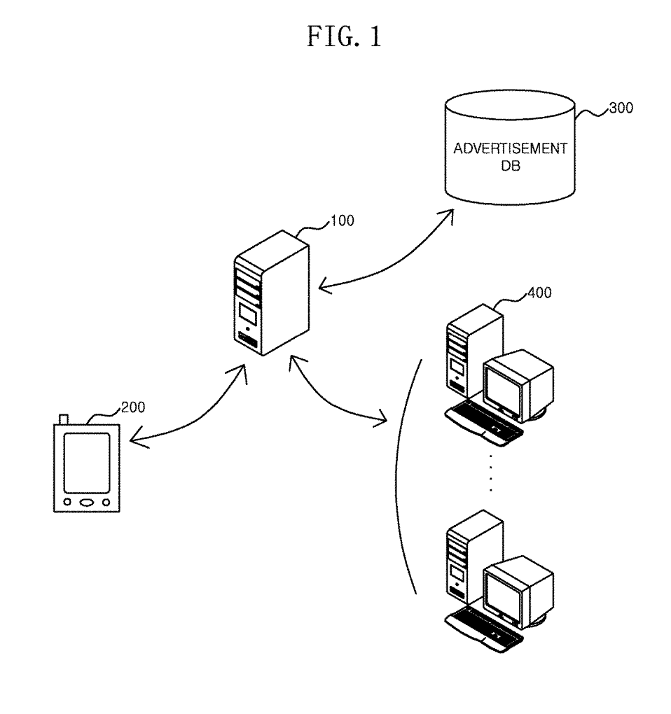

FIG. 1 schematically illustrates a network environment of a location-based advertising system suitable for implementing a location-based advertising method according to an exemplary embodiment of the invention.

Referring to FIG. 1, a location-based advertising system 100 is provided to implement a location-based advertising method according to an exemplary embodiment of the invention. The location-based advertising system 100 may transmit and receive information necessary for implementing the inventive concepts to and from at least one client terminal 200 through wired or wireless communications. For example, the location-based advertisement system 100 may provide predetermined advertisement information to the client terminal 200.

The location-based advertising system 100 may communicate with a plurality of advertiser terminals 400. The advertiser terminals 400 may refer to terminals used by advertisers who advertise their products or companies through the location-based advertisement system 100 according to a technical concept of the present disclosure. Each of the advertiser terminals 400 may be implemented by any kind of data processing device (e.g., a computer, a mobile phone, an Internet Protocol television (IPTV)) capable of communicating with the location-based advertising system 100 to transmit and receive information to and from the location-based advertising system 100.

The location-based advertising system 100 may perform a predetermined bidding process while communicating with the advertiser terminals 400. According to the bidding result, the location-based advertising system 100 may expose an advertisement selected from advertisement information stored in an advertisement database (DB) 300 to the client terminal 200.

The advertisement DB 300 may store advertisement information of the advertisers. Also, the advertisement DB 300 may store various pieces of information for implementing the technical concept of the invention in addition to the advertisement information. For example, for a specific advertisement information, the advertisement DB 300 may store information on the advertiser corresponding to the advertisement information, whether or not the advertiser has won a bid for a specific regional unit, and a regional unit and/or a classification (e.g., product, service, or a category of a product or service) in case that the advertiser has won the bid. Even if the advertiser of a specific advertisement information has not won a bid, the advertisement DB 300 may store the advertiser information and the classification for the advertisement information.

The advertisement DB 300 may be implemented as a physical device separate from the location-based advertising system 100, but may be included in the location-based advertising system 100. The location-based advertising system 100 may determine advertisement information, to be exposed to the client terminal 200, from the advertisement information stored in the advertisement DB 300 according to a location of the client terminal 200 and an action carried out by the client terminal 200 (e.g., a selection of a specific classification). The location-based advertising system 100 may control the determined advertisement information to be exposed in the client terminal 200. In order that the advertisement information is exposed in the client terminal 200, the location-based advertising system 100 may transmit the advertisement information to the client terminal 200. Also, the location-based advertising system 100 may determine the location where the advertisement is to be exposed and perform a predetermined control such that the advertisement is exposed in a determined location. In an alternative embodiment, the advertisement information may be stored in the client terminal 200 in advance and, in such a case, the location-based advertising system 100 may control the client terminal 200 such that the advertisement is exposed in a particular location at a particular time in the client terminal 200.

The advertisement information may be information that the advertiser wishes to be exposed to the client terminal 200. The advertisement information may include, for example, information of a business facility such as a store or an office of the advertiser (e.g., a name, a location, goods or services provided by the store, contacts, and/or opening hours). Also, the advertisement information may be implemented in any kind of data format (e.g., an image, text, moving picture, and/or audio information) if it has some information to be exposed.

The location-based advertising system 100 refers to a system for exposing the advertisement information to the client terminal 200 according to the technical concept of the present disclosure. The location-based advertisement system 100 may be connected to a predetermined service system (not shown) through wired or wireless communications to exposes the advertisement to a service platform such as an application or a web page provided by the service system. The location-based advertisement system 100 may be separate from the service system. However, those having ordinary skills in the art will note that the location-based advertisement system 100 may be incorporated in a single system with the service system.

In an embodiment, the service platform suitable for exposing the advertisements may be used by the advertisers who provide respective services (e.g., selling goods or providing services) based on a geographic location such as the location of the store or an arbitrary location. For example, the service platform may be used by the advertisers selling their goods or providing delivery services within a certain area based on the location of the store. The service platform for the advertisers selling goods or providing the delivery services is mentioned for an exemplary purpose, and the present disclosure is not limited thereto but is applicable to any type of medium including the application programs and web pages.

The location-based advertising system 100 may bid for advertising locations from the advertisers on the regional basis. The regional unit used for the bidding may be a is predetermined administrative area (e.g., block, town, county, city, or the like), or may be an area unit arbitrarily divided as necessary.

According to the present disclosure, a first advertisement area which is determined by the result of bidding for a regional unit and the location of the client terminal 200 receiving the service provided by the location-based advertising system 100 may be set in the service platform displayed on the client terminal 200. The advertisement information to be exposed in the first advertisement area is referred to as first advertisement information.

Also, the service platform displayed on the client terminal 200 may further include a second advertisement area that is different from the first advertisement area in addition to the first advertisement area. The advertisement information to be exposed in the second advertisement area is referred to as second advertisement information.

The second advertisement area for exposing the second advertisement information may be determined regardless of the bidding result.

Thus, the present invention implements the first advertisement area and the second advertisement area in the service platform so as to provide the advertisements fairly by preventing an acquired advertisement from being exposed only or being exposed at a food position for advertising impact in accordance with the result of the bidding.

The second advertisement information may be determined based on the location of the client terminal 200 and an advertiser correspondence location of a corresponding advertiser.

The advertiser correspondence location may be a place representing a business of the advertiser. The advertiser correspondence location may be chosen automatically according to a predetermined criterion, for example, to be the facility (store) of the advertiser. Alternatively, the advertiser correspondence location may be set arbitrarily according to an intent of the advertiser. The invention may allow each advertiser to set a plurality of the advertiser correspondence locations. If the advertiser is allowed to set a plurality of the advertiser correspondence locations, the advertiser may set his or her facility and additional place as the advertiser correspondence locations to use the service platform more effectively and enhance advertising impact.

Meanwhile, the bidding may be executed separately for each product classification. The product classification may be a result of classifying goods or services provided by the advertisers according to predetermined criteria. For example, the product classification may represent a particular product (e.g., a fried chicken) or a category of products (e.g., Korea food or fast food) including a plurality of products. In any case, the location-based advertising system 100 may execute the bidding for the regional units for each product classification. Accordingly, an advertiser who won a bidding for a specific regional unit for a first product classification may be different from another advertiser who won a bidding for the specific regional unit for a second product classification. Thus, when the client terminal 200 performs a predetermined action such as a searching and selection of a product classification to specify the product classification, the advertisement information which corresponds to the specified product classification and have been provided by the advertiser who deals in products in the classification or wants to advertising products in the classification may be exposed in the client terminal 200.

On the other hand, according to the present disclosure, the advertiser correspondence location may be set in advance for each advertiser, and an advertiser correspondence region which may be determined based on the advertiser correspondence is location may defined further. The advertiser correspondence region may represent a service coverage of the advertiser. The present disclosure may take the advertiser correspondence region into account as a factor for determining which advertisement is to be exposed in service platform displayed on the client terminal 200, so that the actual business activities of the advertisers are reflected in the determination of the advertisement to be exposed. Also, the definition of such an advertiser correspondence region makes it possible to solve a problem that a large extent of area in a service coverage of the system may be preoccupied by some advertisers and to provide a fair opportunity for many advertisers.

The range of the advertiser correspondence region may be determined differently depending on the product classification corresponding to the advertiser. For example, in case of a first product classification (e.g., fried chicken, Chinese restaurant, etc.) for which there are a large number of advertisers or advertisers are heavily populated in a certain area, a relatively small region having a radius of one kilometer, for example, around the advertiser correspondence locations may be set as the advertiser correspondence region. Contrarily, in case of a second product classification (e.g., Korean restaurant, Japanese restaurant, etc.) for which there are a few advertisers or advertisers are sparsely populated in a certain area, a relatively large region having a radius of three kilometers, for example, around the advertiser correspondence locations may be set as the advertiser correspondence region.

As described above, the advertiser correspondence regions of the advertisers are determined based on the sales situations of the advertisers such as the number of the advertisers and the distributions of the advertiser correspondence locations, and thus the advertisements may be exposed to adaptively to the sales situations of the advertisers, which may be fair for all the advertisements.

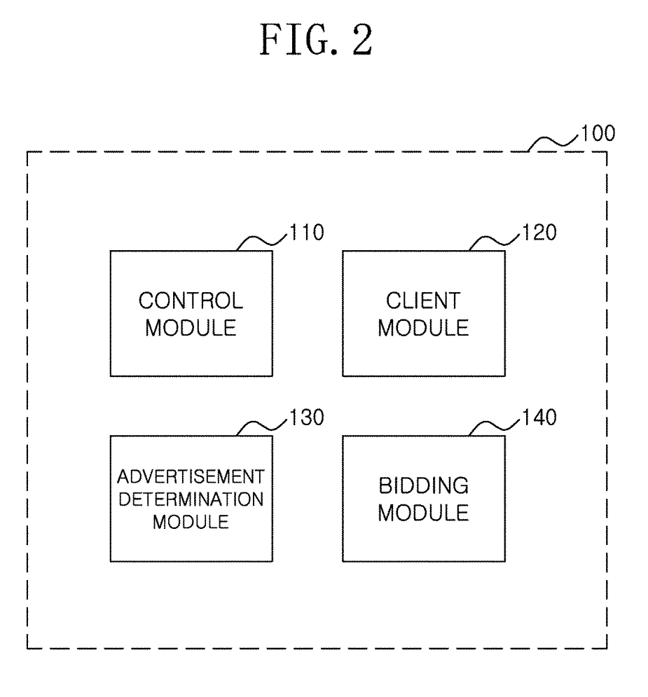

FIG. 2 is a block diagram of the location-based advertising system according to an exemplary embodiment of the invention.

Referring to FIG. 2, the location-based advertising system 100 according to an exemplary embodiment of the invention may include a control module 110, a client module 120, an advertisement determination module 130, and/or a bidding module 140.

Depending on exemplary embodiments, some of the above-described components may not be essential in the implementation of the inventive concepts, and the location-based advertising system 100 may include additional components.

The location-based advertising system 100 may have hardware resources and/or software required to implement the technical concept of the inventive concepts, and does not imply a single physical component or a single device. That is, the location-based advertising system 100 may be a logical combination of hardware and/or software provided to implement the technical concept of the inventive concepts. The location-based advertising system 100 may be implemented by a set of logical configurations installed in devices spaced apart, if necessary, and performing respective functions to implement the technical concept of the present disclosure. Also, the location-based advertising system 100 may mean a set of configurations separately implemented for each function or role to implement the technical concept of the present disclosure. For example, the control module 110, the client module 120, the advertisement determination module 130, and/or the bidding module 140 may be located in separate physical devices or may be located in a physical device. Exemplarily, all or some configurations of the location-based advertising system 100 may be installed in the client terminal 200.

Also, depending on the implementations, a combination of software and/or hardware configurations for implementing each of the control module 110, the client module 120, the advertisement determination module 130, and/or the bidding module 140 may be installed in separate devices a distributed manner, so that the distributed configurations in a combination may implement the particular configuration.

The term ‘module’ used herein may mean a functional and structural combination of hardware for performing the technical concept of the present disclosure and software for driving the hardware. For example, those having ordinary skill in the art will understand that the module may be a predetermined program code and a logical unit of hardware resource for executing the predetermined program code, and does not necessarily mean a physically connected code or a single kind of hardware.

The control module 110 may control functions and/or resources of the configurations of the location-based advertising system 100 such as the client module 120, the advertisement determination module 130, and/or the bidding module 140.

The client module 120 may check the location of the client terminal 200. The client module 120 may receive location information of the client terminal 200 in various ways. For example, the client module 120 may receive the location information (e.g., GPS positioning information) from the client terminal 200, or may receive the location information from a mobile communications system (not shown) which determines the information by use of base station information, triangulation data, or the like. Another positioning scheme may be used for acquiring the positioning information of the client terminal 200.

The advertisement determination module 130 may determine the advertisement information to be exposed in the advertisement areas. As mentioned above, the service platform displayed on the client terminal 200 may include the first advertisement area, and may further include the second advertisement area. The advertisement determination module 130 may determine at least one first advertisement information to be exposed in the first advertisement area and/or at least one second advertisement information to be exposed in the second advertisement area.

The control module 110 may cause the first and the second advertisement information to be exposed in the first and the second advertisement area, respectively.

The advertisement determination module 130 may determine the first advertisement information based on the bidding result for the regional unit and the location of the client terminal 200. For example, the advertisement determination module 130 may determine advertisement information of an advertiser who is the successful bidder for the regional unit including the location of the client terminal 200 as the first advertisement information. The bidding may be executed by the location-based advertising system 100, or may be performed by another methods. When the location-based advertising system 100 executes the bidding, the location-based advertising system 100 may include the bidding module 140 as described above.

Of course, when an action for specifying a product classification is performed in the client terminal 200, the advertisement information which belongs to the product classification and corresponds to the advertiser who succeeded in the bidding for the regional unit including the location of the client terminal 200 may be determined to be the first advertisement information. That is, the bidding may be performed on the regional unit for each product classification.

Also, the advertisement determination module 130 may determine the first advertisement area by further considering the advertiser correspondence region. For example, the advertisement information which belongs to the product classification and corresponds to the advertiser who succeeded in the bidding may not be determined as the first advertisement information if the advertisement information does not satisfy a condition for the advertiser correspondence region, i.e., an advertiser correspondence condition. One condition for the advertiser correspondence region may be that the location of the client terminal 200 is to be included in the advertiser correspondence region. Meanwhile, the advertiser correspondence region maybe set based on the advertiser correspondence locations as mentioned above.

On the other hand, the advertisement determination module 130 may determine the second advertisement information based on the location of the client terminal 200 and the advertiser correspondence location of the corresponding advertiser. Thus, the second advertisement information may be determined regardless of the bidding result. Similarly to the first advertisement information, the advertisement determination module 130 may determine the second advertisement information only when candidate advertisement information satisfies the advertiser correspondence condition.

After the advertisement determination module 130 determines the first and/or the second advertisement information, the control module 110 may cause the advertisement information to be exposed in respective advertisement areas. When there is no advertisement information to be exposed in a predetermined advertisement position, the control module 110 may control another advertisement information to be exposed in another advertisement position to be exposed in the predetermined advertisement position.

The bidding module 140 may execute the bidding for each regional unit by communicating with the advertiser terminals 400. When the service platform services (for example, being sold, ordered, brokered, shipped, or promoted, in the service platform) a plurality of product classifications, the bidding module 140 may execute the bidding process for each regional unit with each of the product classifications.

Also, the bidding module 140 may provide the advertiser terminals 400 with a reasonable reference bidding price for each advertisement area.

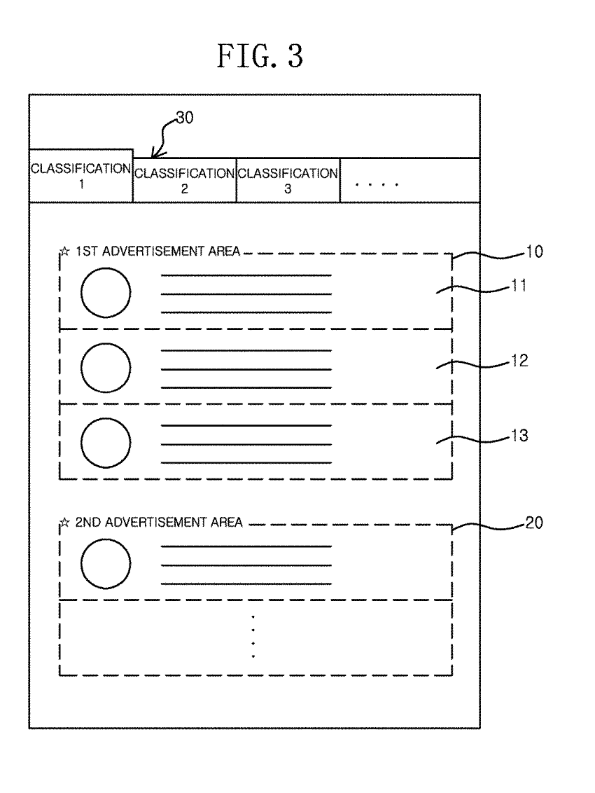

FIG. 3 illustrates advertisement areas according to the location-based advertising method according to an exemplary embodiment of the invention.

The client terminal 200 may display a screen shown in FIG. 3.

For example, the screen or the service platform displayed on the client terminal 200 may include the first advertisement area 10. The first advertisement area 10 may include a plurality of advertisement positions 11, 12, and 13.

Also, the screen or the service platform displayed on the client terminal 200 may include the second advertisement area 20. The second advertisement area 20 may include a plurality of advertisement positions, also.

As shown in FIG. 3, the screen may further include tabs user interface (UI) 30 that shows a current product classification (e.g., CLASSIFICATION 1, CLASSIFICATION 2, CLASSIFICATION 3) and enables a user to change the current product classification.

The first advertisement area 10 may be an area where advertisement information determined based on the bidding result and the location of the client terminal 200 is exposed as described above. Also, when a plurality of advertisement positions 11 to 13 are included in the first advertisement area 10, the bidding may be performed separately for each advertisement position.

The bidding module 140 may provide the reference bidding price to a plurality of advertiser terminals 400 to perform the bidding for the first advertisement position 11. The bidding module 140 may calculate the reference bidding price by converting the advertisement impact of the first advertisement position 11 into an economic value in a predetermined manner.

For example, the bidding module 140 may estimate the reference bidding price of the first advertisement position 11 based on the economic value of the orders generated in the past for a period of time (e.g., past several days, last month, etc.) through the first advertisement position 11.

The orders may refer to orders generated by a plurality of users selecting the first advertisement position 11 during the past period of time. The objects of the orders (i.e., goods or services such as delivery services) may vary depending on the service platform. Of course, only the orders of the product classification used for the bidding and corresponding to the regional unit may be used in the calculation of the economic value. For example, when a bidding is performed for fried chicken products in a first regional unit, only the orders for the fried chicken products generated in the first regional unit may be used in the calculation of the economic value of the past orders in the first advertisement position 11.

For example, the bidding module 140 may extract orders, from an order history database (DB) (not shown), submitted through the first advertisement position 11 in the service platform for the product classification that is the bidding object in the regional unit that is also the bidding object. Here, the orders may have been submitted through advertisement information of a plurality of different advertisers rather than a single specific advertiser. Also, the advertisement information of the advertiser having succeeded in the bidding for a specific regional unit may be excluded from the calculation of the economic value of the past orders if the order does not satisfy the condition for the advertiser correspondence region. Therefore, the advertisement impact or an order-inducing impact may be calculated in terms of the advertisement position rather than the advertisement information.

The economic value of the past orders may be calculated based on a number of orders or based on sales amount. When the calculation is based on the sales amount, the bidding module 140 may receive the sales amount information from a service system providing the service platform or acquire the information from the order history DB. When an accurate sales amount cannot be acquired, the bidding module 140 may estimate sales amount of each order by using an average sales amount. Also, the bidding module 140 may calculate the reference bidding price using various indices such as a sum of the sales amount of individual orders, an average of the sales amount of the individual orders, and the profit ratio for each product classification.

When the reference bidding price is provided by the bidding module 140, the advertisers may relatively accurately understand the advertising impact attainable by succeeding the bidding for the advertisement position, and may reduce the burden of excessive advertisement cost.

The bidding module 140 provides the advertiser terminals 400 with the reference bidding price calculated as above and determines one advertiser selected in a predetermined manner among the advertisers having participated in the bidding at amounts higher than the reference bidding price as a winning bidder. The winning advertiser may be the advertiser who submitted the highest bidding amount, but an advertiser who has bid on a medium amount or another advertiser determined in various ways may be selected as the winning bidder depending on the implementation.

Also, in case that a plurality of advertisers bid on the same amount, the location-based advertising system 100 may select one of the plurality of advertisers as the winning bidder based on history data of the plurality of advertisers such as time period of using the service platform, amount of money spent on the service platform, and sales mount or a number of orders generated the service platform.

The bidding mentioned above may be performed for each of the advertisement positions 11 through 13.

For example, as a result of biddings for a specific product classification and a specific regional unit, the first advertisement position 11 may be sold to a first advertiser, the second advertisement position 12 may be sold to a second advertiser, and the third advertisement position 13 may be sold to a third advertiser.

In such a case, when the client terminal 200 located in the specific regional unit performs an action of selecting the specific product classification, an advertisement of the first advertiser may be exposed in the first advertisement position 11 of the first advertisement area 10, an advertisement of the second advertiser may be exposed in the second advertisement position 12, and an advertisement of the third advertiser may be exposed in the third advertisement position 13.

Meanwhile, according to the invention, the advertiser correspondence region may be taken into account additionally in the determination of the advertisement information to be exposed in the first advertisement area 10. The advertiser correspondence region may correspond to a business coverage of the advertiser set by a predetermined criterion. In such a case, the advertisement determination module 130 may determine the advertisement information such that the advertisement information which does not satisfy The advertiser correspondence region is not exposed in the first advertisement area 10 even if the advertiser corresponding to the advertisement information is the successful bidder.

For example, it is assumed that the first through the third advertisers are successful bidders for the first through the third advertisement locations 11-13, respectively, for the regional unit where the client terminal 200 is located as described above.

At this time, the location of the client terminal 200 may not be included in each of the advertiser correspondence regions of the first through the third advertisers. That is, it is possible that the regional unit that is an object of the bidding does not coincide with the advertiser correspondence region and that, even though the client terminal 200 is located within the regional unit and there is a winning bidder for the regional unit, the client terminal 200 may not be located within the advertiser correspondence region of the winning bidder. In case that the client terminal 200 is not located within the advertiser correspondence region of the winning bidder, the advertisement of the winning bidder may not be exposed in the first advertisement area 10 as well as the second advertisement area 20. This is because the service of the winning bidder may not be provided to the user of the client terminal 200 when the client terminal 200 is not be located within the advertiser correspondence region of the winning bidder even if the advertisement information is exposed to the client terminal 200.

Assuming, in the above example, that only the first advertiser satisfies the advertiser correspondence condition (i.e., the position of the client terminal 200 is included in the first advertiser's advertiser correspondence region) but the second and the third advertisers do not satisfy the respective advertiser correspondence conditions, the advertisement of the second and the third advertisers may not be exposed to client terminal 200 even through the second and the third advertisers are winning bidders. That is, while the advertisement of the first advertiser is exposed in the first advertisement position 11, no advertisement may be exposed in the second and the third advertisement positions 12 and 13.

To the contrary, the first advertiser may not satisfy the advertiser correspondence condition while the second and the third advertisers satisfy the respective advertiser correspondence conditions. In such a case, no advertisement may be exposed in the first advertisement position 11 while the advertisements of the second and the third advertisers are exposed in the second and the third advertisement positions 12 and 13, respectively.

According to another exemplary embodiment, however, when it is determined that the advertisement of the winning bidder (e.g., the first advertiser) of an higher priority advertisement position (e.g., the first advertisement position 11) is not to be exposed, the advertisement determination module 130 may determine that the advertisement of the winning advertiser (e.g., the second advertiser) of another advertisement position (e.g., the second advertisement position 12) of a next priority is to be exposed in the advertisement position (e.g., the first advertisement position 11) of the higher priority. In this case, the advertisement of the second advertiser may be exposed in the first advertisement position 11 and the advertisement information of the third advertiser may be exposed in the second advertisement position 12. Also, depending on the location of the client terminal 200, the advertisement of the first advertiser may be exposed in the first advertisement position 11, or the advertisement of the second or the third advertiser may be exposed in the first advertisement position 11. Thus, even if the winning bidder is determined for each of the advertisement positions 11-13 as a result of the bidding for each of the advertisement positions, the advertisement exposed in the advertisement positions may be changed according to the position of the client terminal 200.

On the other hand, the advertisement information to be exposed in the second advertisement area 20 may be determined based on the advertiser correspondence location of each of the advertisers and the location of the client terminal 200 regardless of the bidding result. The phrase ‘regardless of the bidding result’ means that the advertisement of an advertiser who did not participated in the bidding or who is not the winning bidder may be determined to be exposed in the second advertisement area 20.

Thus, according to the present disclosure, it is possible to additionally provide the advertisement through the second advertisement area 20, and allow the advertisers who are not the winning bidder or did not participated in the bidding to expose their advertisements on the service platform. For example, the second advertisement area 20 may be an area for exposing the advertisement of an advertiser who is not the successful bidder in bidding for the regional unit including the location of the client terminal 200. Of course, in this case, only the advertisement of the advertiser satisfying advertiser correspondence condition may be exposed in the second advertisement area 20. Also, when there are a plurality of advertisement positions in the second advertisement area 20, the advertisement position of a high priority (e.g., the advertisement position located in a upper position in the client terminal 200) may be used to expose the advertisement of an advertiser of which advertiser correspondence location is the closest from the client terminal 200. Thus, the user of the client terminal 200 may acquire more useful information (e.g., a location of a nearby store closest from the user) rather than the advertisement of the winning bidder. Also, the advertisers who did not participated in the bidding or who are not the winning bidder may get chances to expose their advertisements to the users.

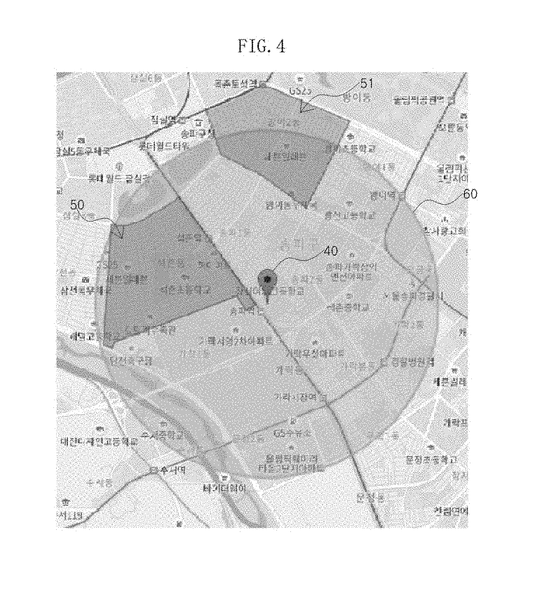

On the other hand, the concept of the regional unit which is the object of a bidding and the advertiser correspondence location will be described in more detail with reference to FIG. 4.

FIG. 4 is a diagram for explaining the regional unit, which is the bidding object according to the location-based advertising method according to an embodiment of the present disclosure, and a corresponding region.

FIG. 4 shows an example in which an advertiser correspondence location 40 of a certain advertiser, regional units acquired in the bidding 50 and 51, and an advertiser correspondence region 60 are displayed on a map.

For example, the advertiser correspondence location 40 may be the location of the facility of the certain advertiser. The advertiser correspondence location 40 may be determined arbitrarily by the certain advertiser irrespectively of the location of the store in case that the certain advertiser has or needs no facility or according to a business strategy of the certain advertiser. Information of the advertiser correspondence location 40 of each advertiser may be stored in advance in the advertisement DB 300.

Also, as shown in FIG. 4, the certain advertiser may be an advertiser who has won the first regional unit 50 and the second regional unit 51 through a predetermined bidding procedure. As shown in FIG. 4, the advertiser may acquire a plurality of regional units. Alternatively, however, the location-based advertising system 100 may be implemented such that any advertiser may acquire one a single regional unit according to a service policy.

The advertiser correspondence region 60 of the certain advertiser may be a region that falls within a predetermined radius from the advertiser correspondence location 40. In such a case, the advertiser correspondence region 60 may be defined as a circular region as shown in FIG. 4. Of course, the advertiser correspondence region 60 may be set in other ways according to the embodiments. For example, the advertiser correspondence region 60 may be set to cover a larger distance from the advertiser correspondence location 40 in a particular direction. At this time, the advertiser correspondence region 60 may be set according to a predetermined criterion based on the advertiser correspondence location 40.

The radius for setting advertiser correspondence region 60 may be adaptively determined according to various factors. For example, the radius may be determined differently for each product classification as described above. In case that the product classification is the fried chicken, the radius may be set to be smaller since there are relatively many fried chicken stores. In case that the product classification is a smoked pork, the radius may be set to be larger since the stores selling and/or delivering the smoked pork products are relatively smaller in their number or distributed more sparsely than the fried chicken products. The control module 110 may set the radius of the advertiser correspondence region 60 for each product classification adaptively according to the advertiser correspondence location 40 or the location of the facility of the advertiser. Depending on the implementations, a larger radius may be set for a particular advertiser according to a service policy, and the advertiser correspondence region 60 may be set adaptively in various ways as necessary.

The advertiser correspondence region 60 may have a significance of providing the advertisers with relatively fair sales opportunities. In case where the service coverage of the advertiser is practically limited within a certain range as in a case of a delivery business, the advertiser correspondence region 60 may represent the business coverage of a corresponding advertiser. Depending on service platforms, there may be various needs for the advertiser correspondence region 60.

Therefore, the advertiser correspondence region 60 may be an important factor in exposing the advertisement of the certain advertiser when the client terminal 200 is located in a predetermined region. Also, the advertisement of the certain advertiser may not be exposed in the client terminal 200 even if the certain advertiser is the winning bidder when the location of the client terminal 200 does not satisfy advertiser correspondence condition, i.e. when the client terminal 200 is not located in the advertiser correspondence region 60 as described above.

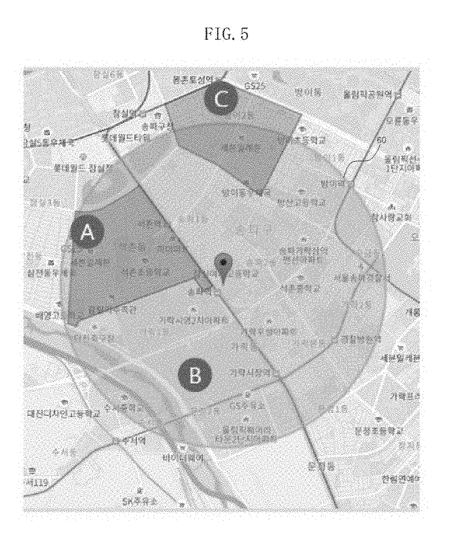

An example of exposing the advertisement information taking into account all of the location of the client terminal 200, the regional units acquired through the bidding procedure, and the advertiser correspondence region 60 will now be described with reference to FIG. 5.

FIG. 5 is a diagram for explaining a process of determining the advertisement information to be exposed according to the location of the user.

If the advertiser correspondence location 40 of the certain advertiser, the regional units acquired in the bidding 50 and 51, and the advertiser correspondence region 60 are the same as those shown in FIG. 4, the position where the advertisement of the certain advertiser is exposed may be different according to the location of the client terminal 200.

For example, if the location of the client terminal 200 is a position ‘A,’ the location of the client terminal 200 may be included in the regional unit acquired in the bidding by the certain advertiser. Also, the location of the client terminal 200 may also be included in the advertiser correspondence region 60 of the certain advertiser. In this case, the advertisement of the certain advertiser may be exposed in the advertisement position 11, 12, or 13 of the first advertisement area 10 acquired by the certain advertiser.

If the location of the client terminal 200 is a position ‘B,’ the location of the client terminal 200 is out of the regional unit acquired in the bidding by the certain advertiser. Thus, the advertisement of the certain advertiser may not be exposed in the first advertisement area 10. However, since the location of the client terminal 200 is included in the advertiser correspondence region 60 of the certain advertiser, the advertisement of the certain advertiser may be exposed in the second advertisement area 20.

If the location of the client terminal 200 is a position ‘C,’ the location of the client terminal 200 is included in the regional unit acquired in the bidding by the certain advertiser but is out of the advertiser correspondence region 60 of the certain advertiser, Thus, the advertisement of the certain advertiser may be exposed neither in the first advertisement area 10 nor in the second advertisement area 20.

Depending on the implementations, when the client terminal 200 is located within the regional unit acquired in the bidding (e.g., in the position ‘C’), the advertisement of the certain advertiser may be exposed in the second advertisement area 20 even though the advertisement is not exposed in the first advertisement area 10. In other words, the second advertisement area 20 may be set to expose the advertisement regardless of the advertiser correspondence region 60 as long as a condition of the product classification is met.

Meanwhile, the situation that the client terminal 200 is located within the regional unit acquired in the bidding but is out of the advertiser correspondence region 60 (e.g., in the position ‘C’) may happen because within the regional unit which is the object of the bidding does not coincide with the advertiser correspondence region 60. In such a situation, the certain advertiser may be charged with unreasonable advertising costs.

To solve this potential problem, the regional unit which is the object of the bidding may be divided according to prescribed administrative districts but the advertiser correspondence region 60 may be partially adjustable in a predetermined manner rather than being set uniformly to have a circular shape with a fixed radius.

For example, the advertiser correspondence region 60 may be partially adjusted automatically to cover acquired regional unit acquired in the bidding or by drawing acquired advertiser correspondence region 60 on a map displayed in a predetermined terminal such as the terminal of the advertiser or another terminal used by an operator of the location-based advertising system 100.

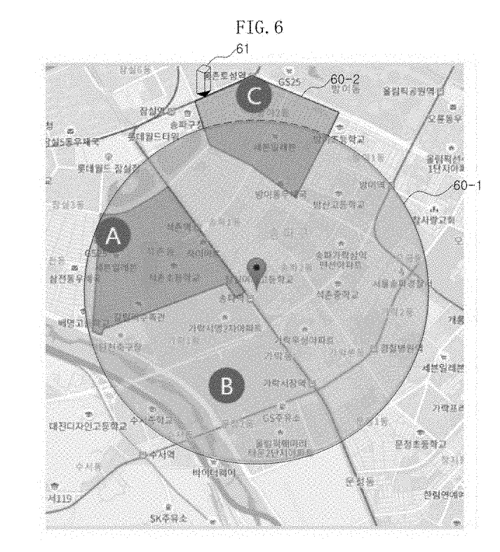

One example of such an exemplary embodiment will be described with reference to FIG. 6.

FIG. 6 is a diagram for explaining a concept of setting the advertiser correspondence region according to the location-based advertising method according to an exemplary embodiment of the invention.

Referring to FIG. 6, the advertiser correspondence region 60 of the specific advertiser may be set based on a reference area 60-1, which is a circular region centered at the advertiser correspondence location 40. If there is a portion of the regional unit acquired in the bidding that is not included in the reference area 60-1 (e.g. the region 60-2, which covers the position ‘C’ but is not included in the reference area 60-1), the advertiser correspondence region may be adjusted based on the reference area 60-1 to include the region 60-2. For example, the advertisement determination module 130 may automatically adjust the advertiser correspondence region to include the region 60-2. Alternatively, the advertisement determination module 130 may receive a drawing action command for identifying the region 60-2 from the terminal of the advertiser or the operator of the location-based advertising system 100 to include the region 60-2 identified by the drawing action command into the advertiser correspondence region. The location-based advertising system 100 may provide the predetermined terminal such as the terminal of the advertiser or the operator of the location-based advertising system 100 with a predetermined user interface (UI) 61, so that the user of the terminal may input the drawing action command for adjusting the advertiser correspondence region through the UI 61. The terminal may identify the region 60-2 by a drawing action. Thus, the advertiser correspondence region may be expanded to include the region 60-2 compared with the advertiser correspondence region shown in FIG. 5.

Depending on the implementations, the advertiser correspondence region may be determined to have the same preset area even after the adjustment. In this case, when the area 60-2 is added to the advertiser correspondence region, another area in the advertiser correspondence region may be excluded from the advertiser correspondence region automatically or manually.

Alternatively, the advertiser correspondence region may be set through a drawing action performed by the predetermined terminal from the beginning rather than being automatically set as the circular area with the predetermined radius.

Besides, the advertiser correspondence region may be set in various manners.

Meanwhile, when the advertiser correspondence region is set in a predetermined manner based on the advertiser correspondence location 40, the setting of the advertiser correspondence location 40 may be critical to the sales or advertising strategy of the advertiser.

Thus, the present disclosure allows the advertiser to arbitrarily set the advertiser correspondence location according to the intention of the advertiser instead of using the location of the facility of the advertiser. Further, the invention allows the advertiser to set a plurality of the advertiser correspondence locations as necessary or according to a service policy.

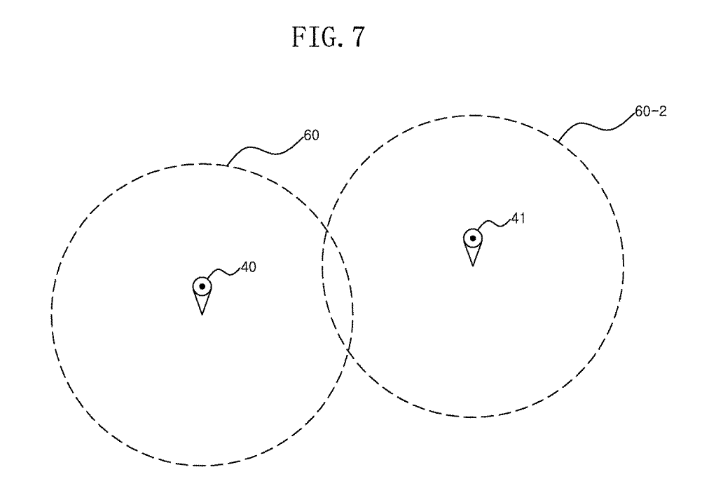

One example of such an exemplary embodiment will be described with reference to FIG. 7.

FIG. 7 is a diagram for explaining a concept of setting a plurality of advertiser correspondence locations according to the location-based advertising method according to an exemplary embodiment of the invention.

Referring to FIG. 7, a plurality of advertiser correspondence locations 40 and 41 may be set for a certain advertiser. Also, the regions 60 and 60-2 within a certain radius for each of the advertiser correspondence locations 40 and 41 may be set to be the advertiser correspondence regions of the advertiser.

There may be cases where an advertiser needs to set up a wider range of business, or a business environment of the advertiser requires a wider business range. In case where a plurality of advertiser correspondence locations 40 and 41 may be set as described above, the invention may allow each advertiser to set up an advertisement strategy in consideration of the above requirements rather than determining and maintaining a uniform business scope.

Of course, the location-based advertising system 100 may charge additional fee to an advertiser having set a plurality of advertiser correspondence locations according to a service policy.

The location-based advertising system 100 and the location-based advertising method performed by the location-based advertising system 100 may be applicable to various service platforms. For example, the invention may be applied to a service platform configured to receive an order for a food delivery service or intermediate such an order. However, the inventive concepts are not limited thereto but may be applied to various service platforms as needed. In particular, the invention may be particularly useful for a service platform in which it is necessary to expose different pieces of advertisement information depending on the location of the user and the advertisers want to expose their advertisements selectively to the users located within a certain regional range.

The location-based advertising method according to exemplary embodiments of the invention may be embodied as computer readable program instructions stored in a computer readable recording medium. A control program and an object program according to embodiments of the present disclosure may be stored in the computer readable recording medium. The computer readable recording medium includes all sorts of recording devices in which data readable by a computer system are stored.

The program instructions stored in the recording medium may be program instructions specially designed and constructed for the present disclosure or program instructions known and available to a person skilled in the field of software.

Examples of the computer readable recording medium include magnetic media, such as a hard disk, a floppy disk, and a magnetic tape; optical media, such as compact disc read only memory (CD-ROM) and a digital versatile disk; magneto-optical media, such as a floptical disk; and other hardware devices specially designed to store and execute program instructions, such as read only memory (ROM), random access memory (RAM), and flash memory. In addition, the recording medium may be in the form of light or a carrier wave that conveys signals specifying program instructions, data structures, or the like, or a transmission medium, such as a metal wire or a waveguide, through which the signals are transmitted. Furthermore, the computer readable recording medium may be distributed to computer systems connected by means of a network, in which computer readable codes are stored and executed in a decentralized manner.

Examples of the program instructions include not only machine language codes generated by compilers, but also advanced language codes that may be executed by an information processing device, for example, a computer, that electronically processes information using an interpreter.

The hardware devices described above may be constructed such that they can operate as one or more software modules for performing the operations of the present disclosure, and vice versa.

While the invention has been illustrated and described with reference to the certain exemplary embodiments thereof, it will be understood by those skilled in the art that various changes in form and details may be made therein without departing from the spirit and scope of the present disclosure as defined by the appended claims. Therefore, the foregoing embodiments should be understood as being illustrative but not limitative purposes. For example, some parts described as being located in a single physical entity can be implemented as being distributed to a plurality of physical devices. In the same fashion, some parts described as being distributed to a plurality of physical devices can be located in a single physical entity.

The scope of the invention is defined not by the detailed description but by the appended claims, and all modifications and alterations derived from the concept, the range, and the equivalents of the claims will be construed as being included in the scope of the present disclosure.

The invention may be applicable to a location-based advertising method and a system for implementing the method.

1. A location-based advertising method, comprising:
identifying a location of a client terminal by a location-based advertising system;
determining at least one first advertisement information and at least one second advertisement information, based on the location of the client terminal, to be exposed in a first advertisement area and a second advertisement area, respectively, displayed on the client terminal; and
causing the at least one first advertisement information and the at least one second advertisement information to be exposed in the first advertisement area and the second advertisement area, respectively,
wherein:
the at least one first advertisement information is determined based on a result of a bidding performed for regional units and the location of the client terminal; and
the at least one second advertisement information is determined based on the location of the client terminal and an advertiser correspondence location corresponding to each advertisement information.

2. The method of claim 1, further comprising:
performing a bidding process for each of product classifications by the location based advertising system,
wherein, in the operation of determining the at least one first advertisement information and the at least one second advertisement information, after a particular product classification is selected by the client terminal, advertisement information of a bid-winning advertiser having acquired a regional unit corresponding to the location of the client terminal for the particular product classification is determined as the first advertisement information.

3. The method of claim 2, wherein the operation of determining the at least one first advertisement information and the at least one second advertisement information comprises:
determining whether the location of the client terminal satisfies a correspondence region condition that the location of the client terminal belongs to an advertiser correspondence region of the bid-winning advertiser that is predetermined based on an advertiser correspondence location of the bid-winning advertiser; and
determining the advertisement information of the bid-winning advertiser as the first advertisement information only when the location of the client terminal satisfies the correspondence region condition.

4. The method of claim 3, wherein the operation of determining the at least one first advertisement information and the at least one second advertisement information comprises:
when the location of the client terminal does not satisfy the correspondence region condition, determining the advertisement information of the bid-winning advertiser as neither the first advertisement information nor the second advertisement information.

5. The method of claim 3, wherein the advertiser correspondence region is a region that falls within a predetermined radius from the advertiser correspondence location.

6. The method of claim 5, wherein the radius is set differently for each of the product classifications.

7. The method of claim 5, wherein, when a portion of the regional unit acquired by the bid-winning advertiser is not included in a reference area that falls within a predetermined radius from advertiser correspondence location, the advertiser correspondence region is set to include the portion of the regional unit acquired by the bid-winning advertiser or to include a drawing region designated on a map in a predetermined terminal.

8. The method of claim 3, wherein the first advertisement area includes a plurality of predetermined advertisement positions, and a bid-winning advertiser is determined for each of the plurality of predetermined advertisement positions based on the result of the bidding.

9. The method of claim 8, wherein the operation of causing the at least one first advertisement information and the at least one second advertisement information to be exposed comprises:
when it is determined that a first bid-winning advertiser having acquired a first advertisement position does not satisfy the correspondence region condition and a second bid-winning advertiser having acquired a second advertisement position which has a lower priority than the first advertisement position satisfies the correspondence region condition, causing advertisement information of the second bid-winning advertiser to be exposed in the first advertisement position having a higher priority than the second advertisement position.

10. The method of claim 1, further comprising performing a bidding process for each of at least one advertisement position in the first advertisement area including the at least one advertisement position,
wherein the operation of performing the bidding process comprises:
calculating a reference bidding price for each of the at least one advertisement position based on an economic value of orders generated in a predetermined past period of time through the each of at least one advertisement position; and
performing the bidding process based on the reference bidding price calculated for each of the at least one advertisement position.

11. The method of claim 10, wherein the orders generated through the each of at least one advertisement position includes orders placed through advertisement information of advertisers other than the bid-winning advertiser in addition to the bid-winning advertiser.

12. The method of claim 1, wherein the advertiser correspondence location includes a location of a facility of an advertiser, and optionally a position chosen by the advertiser.

13. The method of claim 1, wherein, in the operation of determining the at least one first advertisement information and the at least one second advertisement information, after a particular product classification is selected by the client terminal, advertisement information of a second advertiser who is not the bid-winning advertiser among advertisers corresponding to the particular product classification and whose advertiser correspondence region covers the location of the client terminal is determined as the second advertisement information.

14. The method of claim 13, wherein the operation of causing the at least one first advertisement information and the at least one second advertisement information to be exposed comprises:
exposing the advertisement information of the at least one second advertiser in an advertisement position having a high priority in an order of the closest distance between the advertiser correspondence location of each of the at least one second advertisers and the location of the client terminal.

15-17. (canceled)

18. A location-based advertising method, comprising:
selecting a bid-winning advertiser by performing a bidding process for each of plural advertisement positions to expose advertisement information in an advertisement area including the plural advertisement positions;
identifying a location of a client terminal; and
determining at least one advertisement information to be exposed in the advertisement area, which includes the plural advertisement positions and is to be displayed on the client terminal, based on the location of the client terminal,
wherein:
the operation of determining at least one advertisement information comprises, when it is determined that a first bid-winning advertiser having acquired a first advertisement position does not satisfy a correspondence region condition and a second bid-winning advertiser having acquired a second advertisement position which has a lower priority than the first advertisement position satisfies the correspondence region condition, causing advertisement information of the second bid-winning advertiser to be exposed in the first advertisement position having a higher priority than the second advertisement position; and
the correspondence region condition is determined to be satisfied when an advertiser correspondence region of an advertiser that is predetermined based on an advertiser correspondence location of the advertiser covers the location of the client terminal.

19. A computer program stored in a computer-readable storage medium to be installed in a data processing apparatus and for executing the method claimed in claim 1.

20. A location-based advertising system, comprising:
a client module configured to identify a location of a client terminal;
an advertisement determination module configured to determine at least one first advertisement information and at least one second advertisement information, based on the location of the client terminal, to be exposed in a first advertisement area and a second advertisement area, respectively, displayed on the client terminal; and
a control module configured to cause the at least one first advertisement information and the at least one second advertisement information to be exposed in the first advertisement area and the second advertisement area, respectively,
wherein the advertisement determination module determines the at least one first advertisement information based on a result of a bidding performed for regional units and the location of the client terminal, and determines the at least one second advertisement information based on the location of the client terminal and an advertiser correspondence location corresponding to each advertisement information.

21. The system of claim 20, further comprising a bidding module configured to perform a bidding process for each of product classifications,
wherein the advertisement determination module, after a particular product classification is selected by the client terminal, determines advertisement information of a bid-winning advertiser having acquired a regional unit corresponding to the location of the client terminal for the particular product classification as the first advertisement information.

22. The system of claim 21, wherein the advertisement determination module determines whether the location of the client terminal satisfies a correspondence region condition that the location of the client terminal belongs to an advertiser correspondence region of the bid-winning advertiser that is predetermined based on an advertiser correspondence location of the bid-winning advertiser; and determines the advertisement information of the bid-winning advertiser as the first advertisement information only when the location of the client terminal satisfies the correspondence region condition.

23. The system of claim 22, wherein the first advertisement area includes a plurality of predetermined advertisement positions, and the bid-winning advertiser is determined for each of the plurality of predetermined advertisement positions based on the result of the bidding.

24. The system of claim 23, wherein, when it is determined that a first bid-winning advertiser having acquired a first advertisement position does not satisfy the correspondence region condition and a second bid-winning advertiser having acquired a second advertisement position which has a lower priority than the first advertisement position satisfies the correspondence region condition, the control module causes advertisement information of the second bid-winning advertiser to be exposed in the first advertisement position having a higher priority than the second advertisement position.

25. The system of claim 20, further comprising a bidding module configured to perform a bidding process for each of at least one advertisement position in the first advertisement area including the at least one advertisement position,
wherein the bidding module calculates a reference bidding price for each of the at least one advertisement position based on an economic value of orders generated in a predetermined past period of time through the each of at least one advertisement position, and performs the bidding process based on the reference bidding price calculated for each of the at least one advertisement position.

26. The system of claim 20, wherein the advertiser correspondence region includes a location of a facility of an advertiser, and optionally a position chosen by the advertiser.

27. The system of claim 20, wherein, after a particular product classification is selected by the client terminal, the advertisement determination module determines advertisement information of a second advertiser who is not the bid-winning advertiser among advertisers corresponding to the particular product classification and whose advertiser correspondence region covers the location of the client terminal as the second advertisement information.

28-30. (canceled)

31. A location-based advertising system, comprising:
a bidding module configured to select a bid-winning advertiser by performing a bidding process for each of at least one advertisement position to expose advertisement information in an advertisement area including the at least one advertisement position;
a client module configured to identify a location of a client terminal;
an advertisement determination module configured to determine at least one advertisement information to be exposed in the advertisement area, which includes the at least one advertisement position and is to be displayed on the client terminal, based on the location of the client terminal; and
a control module configured to, when it is determined by the advertisement determination module that a first bid-winning advertiser having acquired a first advertisement position does not satisfy a correspondence region condition and a second bid-winning advertiser having acquired a second advertisement position which has a lower priority than the first advertisement position satisfies the correspondence region condition, cause advertisement information of the second bid-winning advertiser on the first advertisement position having a higher priority than the second advertisement position,
wherein the correspondence region condition is determined to be satisfied when an advertiser correspondence region of an advertiser that is predetermined based on an advertiser correspondence location of the advertiser covers the location of the client terminal.

32. A computer program stored in a computer-readable storage medium to be installed in a data processing apparatus and for executing the method claimed in claim 15.

33. A computer program stored in a computer-readable storage medium to be installed in a data processing apparatus and for executing the method claimed in claim 17.

34. A computer program stored in a computer-readable storage medium to be installed in a data processing apparatus and for executing the method claimed in claim 18.
